(19) United States
(12) Patent Application Publication
(10) Pub. No.: US 2005/0000737 A1
(43) Pub. Date: Jan. 6, 2005

(54) Draughtscale for weighing draught beer

(76) Inventors: Wendy Mae Fox, Duntroon (CA); Sheryl Lynn Sheffield, Wasaga Beach (CA); Wayne Kingdon Pester, Duntroon (CA)

Correspondence Address: Dowell & Dowell, P. C., 1215 Jefferson Davis Highway, Suite 309, Arlington, VA, 22202-3124, US

(21) Appl. No.: 10/648,711

(22) Filed: Aug. 27, 2003

(30) Foreign Application Priority Data
Jul. 2, 2003 (CA) 2,432,918

(51) Int. Cl. G01G 19/00

(52) U.S. Cl. 177/245

(57) ABSTRACT

This is a weighing scale specifically designed for the weighing of kegs in the bar and restaurant industry. It is comprised of a stainless steel surface, a digital display unit that measures in ounces, a reset button and a slip resistant underbottom. The scale will also be able to withstand temperatures 4 degrees Celsius and lower so that it can remain a permanent fixture inside the refrigeration unit.

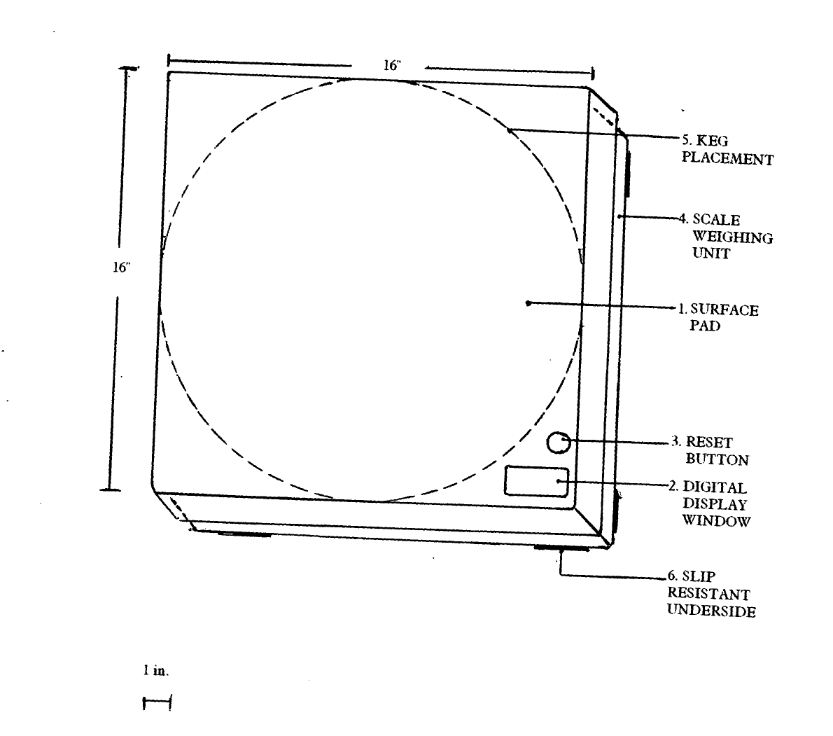

The subject invention relates to an apparatus for weighing and measuring the volume of draught beer within a keg.

### CROSS-REFERENCE TO RELATED APPLICATIONS

Canadian Patent Documents

| | | | |
|---|---|---|---|
| CA 2067096 | September 1990 | Teller, et al | G01G 19/415 |

U.S. Patent Documents

| | | | |
|---|---|---|---|
| 3616690 | November 1971 | Harden | 177/245 |
| 4336855 | June 1982 | Chen | 177/245 |
| 4923024 | May 1990 | Ferrer, et al | 177/245 |
| 4113039 | September 1978 | Ozaki et al | 77/25.19 |

### STATEMENTS REGARDING FEDERALLY SPONSORED RESEARCH OR DEVELOPMENT

Not Applicable

### REFERENCE TO SEQUNCE LISTING, A TABLE, OR A COMPUTER PROGRAM LISTING APPENDIX

Not applicable

### BACKGROUND OF THE INVENTION

There are numerous known devices which presently exist for measuring the weight of any given matter. Such devices are available in variable sizes, materials, mechanical elements, methods for displaying the resulting information and other such components that are designed and constructed to best accommodate the matter being weighed. The subject invention modifies such a device for the weighing of a keg of draught beer, taking into account the space available to do so, the environment of which it shall be stored, the frequency of use and the necessity of accurate volume readings in the bar/restaurant industry, all of which collectively, best accommodate the stated purpose.

The absence of the said apparatus in such establishments makes it difficult to determine the volume of keg contents at any given time. Currently, the volume is generally determined by lifting the keg manually and approximating its contents. This practice is ineffective and inferior for several reasons.

Firstly, without an accurate inventory control system for determining the amount of draught being dispensed, the incidence of employee theft in an establishment is increased. A bar or restaurant may employ one or more bartenders, who collectively dispense significant amounts of draught beer totaling hundreds of dollars. In such establishments, for example, a bartender may dispense the correct serving amount of draught, collect the payment and subsequently does not record the sale on the register, with the intention of personally profiting from the transaction. This employee is committing a form of theft that is difficult to detect.

Currently, a common dilemma for restaurant/bar management is running out of product or having too much inventory in storage, as many decision makers rely on the insufficient end of day sales reports, which may categorize draught sales too vaguely. For example, by grouping individual draught brands as imported”, “domestic” or “premium” sales, as opposed to the individual brand sales.

### BRIEF SUMMARY OF THE INVENTION

The subject invention relates to an apparatus for weighing and measuring the volume of draught beer within a keg and the above problems by allowing for the convenient, controlled and accurate documentation of all draught beer being dispensed.

The design of the apparatus conveniently allows for the permanent placement of the unit in the location of which it will be used. Following the suggested procedures for how and when to take readings provides management with detailed accounts of the time frame and by whom any discrepancies have occurred. The volume reading will be displayed in the unit of ounces for accuracy.

The detailed reports resulting from the use of the said invention and the implementation of the suggested procedures, allow the establishment owner/manager to practice a more thorough and productive decision making process. Specifically, (i) placing more accurate orders to suppliers, therefore reducing the common dilemma of running out of product or having too much inventory in storage, (ii) being equipped with the knowledge of what product is selling and what isn't.

In addition, any discrepancies with the suppliers regarding keg volume at time of purchase can be easily resolved by taking a volume reading before any draught is dispensed.

### BRIEF DESCRIPTION OF DRAWINGS

The drawing illustrates the inventive apparatus, comprised of a surface for supporting the keg (1), in which envelopes the top portion of unit, an automatic digital display window (2), a push button (3) that functions together with said digital display mechanisms for clearing and resetting volume reading, and the unit (4) housing all mechanics and other internal components. The perimeter and height dimensions, the positioning of a keg (5) with a 16″ diameter and the slip resistant underside (6) in the form of four thin rubber pieces, one in each corner 6 are also represented.

### DETAILED DESCRIPTION OF THE INVENTION

The apparatus for weighing and measuring the contents within a keg of draught beer is featured by the fact that the design and construction, comprised of the above specifications, collectively accommodates the said purpose.

The support surface and consequently, the unit in its entirety, shall have dimension of 16″×16″, shall be constructed of stainless steel and shall encompass the greater top portion of the weighing unit.

The said dimensions will accommodate a keg of beer with a diameter of 16″ or less and will permit easy storage or permanent placement of the unit, while utilizing the least amount of space possible. This is optimal, as the space available and refrigeration unit size varies from establishment to establishment. Some units are designed to hold just one keg. Others are used to store all items requiring refrigeration.

Constructing the support surface (1) with stainless steel address s the concerns of durability and sanitation.

The apparatus will endure repeated contact with large, heavy and cumbersome kegs and will therefore require the durability provided by stainless steel.

Furthermore, wherein a keg may be stored in a refrigeration unit also storing food items, sanitation becomes an issue. Of the materials available for construction of the support surface, stainless steel best addresses the said issue due to its capability to be successfully sterilized against bacteria.

The digital display component (2) comprises of such characteristics as measurement unit in ounces, optimal location and easily read digits. The apparatus shall measure volume in the unit of ounces. This mode is of importance as (i) a keg at full capacity weighs over 100 lbs and therefore would commonly be weighed in pounds and (ii) the bar/restaurant industry customarily records draught beer inventory in ounces, therefore no unit conversion is required on part of the user.

The location of the digital display window will be at the front of the apparatus, embedded into the stainless steel with the digits facing the user. It will be situated in the right hand corner.

Positioning the display window in the said location provides the element of convenience as the user then has an unobstructed view of the digits. This is efficient and time saving, taking into account the number of volume readings taken in a day and of the chaos during bartender changeover.

Positioning the display window in the right hand corner of the support surface allows the unit to remain 16″×16″, as opposed to positioning the window in the front center, in which case the dimensions become larger to accommodate the extra space required.

The digits displayed in the digital display window shall be designed for optimal visibility and the decreased possibility for error. Specifically, they will be no less than ½ inch in height, they will b of a high contrast color to the background and they will face th user.

The apparatus shall be designed to withstand temperatures of 4 degrees Celsius or lower in order for the scale to remain in the refrigeration unit. Thus, a keg may be permanently placed on it.

The apparatus features a push button, (3) or reset button, for clearing the display window information. The mechanics of the reset button functions with the digital display mechanisms and shall enable a new volume reading without having to remove the keg. The digital display shall be equipped with a delayed shut off system, clearing the window seconds after the reading is displayed. The delayed shut off will extend battery life, and as a result, the permanent placement of the keg on the apparatus shall be more cost-effective.

The unit (4) housing all internal components shall feature a slip resistant bottom and a height of 2″ or less.

The apparatus shall be slip resistant (6) by means of four thin rubber pieces on the underside of the unit, one on each corner. Refrigeration units are often tiled, therefore, may be slippery. The slip resistant feature will keep the unit secure while a keg is being placed on it, thus addressing any potential safety hazards.

The height of the entire apparatus shall be 2″ or less. This height allows the unit to be space efficient for reasons previously stated. The low height also prevents the user from having to lift the keg too high onto the unit, to avoid injury.

1. An apparatus for automatically determining the weight of the contents within a keg of draught beer comprising of: (i) a surface for supporting the keg, (ii) an automatic digital display window, (iii) a push button that functions together with said digital display window intended for clearing and resetting volume reading, (iv) mechanics and materials with a tolerance for low temperatures, (v) a unit housing all mechanics and other components of the apparatus.

2. The apparatus of claim 1, wherein the said support surface, or weighting pad, will have dimensions of 16″×16″, so as to accommodate one keg of draught beer of which has a diameter of 16″ or less.

3. The apparatus of claim 2, wherein the weight pad of stated dimensions, permits easy storage or permanent placement and utilizes the least amount of space possible.

4. The apparatus of claim 1, wherein the support surface shall be constructed of stainless steel, enveloping the top portion of the housing unit.

5. The apparatus of claim 4, wherein the said stainless steel support surface meets the industry standards for durability and sanitation.

6. The apparatus of claim 1, wherein the automatic digital display reads in units of ounces.

7. The apparatus of claim 6, wherein the said digital display reading in ounces, is of significance as (i) a keg at full capacity weighs over 100 lbs and therefore would commonly be weighed in pounds and (ii) the bar/restaurant industry customarily records draught beverage inventory in ounces.

8. The apparatus of claim 1, wherein the digital display window is located on the supporting surface in the right hand corner of the unit, nearest to the user (see drawing).

9. The apparatus of claim 8, wherein the said location will allow the unit to remain 16″×16″, thus, accommodating even the smallest sized refrigeration unit designed to hold keg beer.

10. The apparatus of claim 8, wherein the said location of the display window enables the user to read the digital display without obstruction

11. The apparatus of claim 1, wherein the digits visible in the digital display window are presented facing the user in an upright position.

12. The apparatus of claim 1, wherein the digits within the digital display window are of high contrast to the background for optimal visibility.

13. The apparatus of claim 1, wherein the digital display window is constructed of material able to withstand repeated contact with kegs.

14. The apparatus of claim 1, wherein the push button, or reset button is designed with a delayed shut off mechanism to save battery power while the unit is not in use.

15. The apparatus of claim 14, wherein the said reset button preserves battery power while the unit is not in use.

16. The apparatus of claim 14, wherein the said reset button allows the keg of beer to remain permanently seated on the support surface.

17. The apparatus of claim 14, wherein the said reset button is located above the digital display window.

18. The apparatus of claim 17, wherein the said location of the reset button allows the unit to remain 16″×16″.

19. The apparatus of claim 1, wherein the mechanics and materials, or draughscale unit can withstand temperatures of 4 degrees Celsius or lower.

20. The apparatus of claim 19, wherein the said draughtscale unit can remain permanently in a refrigeration unit, where draught beer is kept.

21. The apparatus of claim 1, wherein the unit draughtscale unit shall have a slip resistant underbottom.

22. The apparatus of claim 1, wherein the unit shall be 2″ in height or less.

23. The apparatus of claim 24, wherein the said height allows the amount of times the keg will be lifted is minimal for the user.

24. The apparatus of claim 24, wherein the said height of the unit accommodates even the smallest sized refrigeration unit designed to hold.
